(19) United States
(12) Patent Application Publication
(10) Pub. No.: US 2012/0320493 A1
(43) Pub. Date: Dec. 20, 2012

(54) MULTILAYER CERAMIC ELECTRONIC COMPONENT AND MANUFACTURING METHOD THEREOF

(75) Inventors: Chung Eun Lee, Suwon (KR); Doo Young Kim, Suwon (KR); Seon Cheol Park, Suwon (KR); Jae Yeol Choi, Suwon (KR)

(73) Assignee: SAMSUNG ELECTRO-MECHANICS CO., LTD.

(21) Appl. No.: 13/491,254

(22) Filed: Jun. 7, 2012

(30) Foreign Application Priority Data
Jun. 16, 2011 (KR) 10-2011-0058277

(51) Int. Cl. H01G 4/30; B05D 5/00

(52) U.S. Cl. 361/301.4; 427/58

(57) ABSTRACT

There are provided a multilayer ceramic electronic component and a manufacturing method thereof. The multilayer ceramic electronic component includes: a body part including internal electrodes and dielectric layers and having at least one connection surface to which a portion of the internal electrodes are exposed; external electrodes coupled to the connection surface to thereby be electrically connected to the internal electrodes; and protective layers provided on the connection surface so as to shield at least portions of the internal electrodes exposed at the connection surface, wherein a width of an exposed part of the internal electrode shielded by the protective layer has 0.8 to 0.9 of that of an overall width of the internal electrode.

### CROSS-REFERENCE TO RELATED APPLICATIONS

This application claims the priority of Korean Patent Application No. 10-2011-0058277 filed on Jun. 16, 2011, in the Korean Intellectual Property Office, the disclosure of which is incorporated herein by reference.

### BACKGROUND OF THE INVENTION

1. Field of the Invention

The present invention relates to a multilayer ceramic electronic component having excellent reliability, and a manufacturing method thereof.

2. Description of the Related Art

A multilayer ceramic electronic component, a component including a plurality of ceramic dielectric sheets and internal electrodes interposed between the plurality of ceramic dielectric sheets therein to serve as a capacitor, may implement high capacitance even while having a small size, and may easily be mounted on a substrate. Therefore, a multilayer ceramic electronic component has been widely used as a capacitive component in various electronic devices.

Recently, as electronic products have tended to be miniaturized and multi-functionalized, chip components have also tended to be miniaturized and multi-functionalized. Therefore, a multilayer ceramic electronic component capable of providing high capacitance, even while having a small size, has also been demanded. In accordance with this tendency, research into a multilayer ceramic electronic component capable of providing high capacitance even while having a small size by significantly reducing a cover thickness and a margin width has been conducted.

However, in the case of manufacturing the multilayer ceramic electronic component providing high capacitance, even while having a small size, impurities such as conductive foreign materials, moisture, ions, and the like, may penetrate from a surface on which an external electrode is formed through a corner part thereof having a relatively thin thickness to deteriorate insulation resistance, thereby reducing reliability. This defect may be further intensified, particularly in a multilayer ceramic electronic component in which cover thickness and margin width are significantly reduced.

### SUMMARY OF THE INVENTION

An aspect of the present invention provides a multilayer ceramic electronic component capable of providing high capacitance even while having a small size and having excellent reliability, and a manufacturing method thereof.

According to an aspect of the present invention, there is provided a multilayer ceramic electronic component including: a body part including internal electrodes and dielectric layers and having at least one connection surface to which a portion of the internal electrodes are exposed; external electrodes coupled to the connection surface to thereby be electrically connected to the internal electrodes; and protective layers provided on the connection surface so as to shield at least portions of the internal electrodes exposed at the connection surface, wherein a width of an exposed part of the internal electrode shielded by the protective layer may be 0.8 to 0.9 of that of an overall width of the internal electrode.

The protective layer may be formed so as to be adjacent to an edge of the connection surface.

The edge of the connection surface may be perpendicular a width direction of the internal electrode.

The protective layer may be formed so as to be adjacent to an apex of the connection surface.

The protective layer may be formed between the connection surface and the external electrode.

A distance between the protective layer and the external electrode may be smaller than a distance between the connection surface and the external electrode.

The protective layer may be formed of the same material as that of the dielectric layer.

According to another aspect of the present invention, there is provided a method of manufacturing a multilayer ceramic electronic component, the manufacturing method including: manufacturing a body part by multi-layering internal electrodes and dielectric layers; forming protective layers on partial regions of a connection surface to which at least portions of the internal electrodes in the body part are exposed, the protective layers shielding at least portions of the internal electrodes exposed at the connection surface; and providing external electrodes on the connection surface on which the protective layers are formed, wherein the forming of the protective layers is performed so that the overall width of the internal electrode and a width of an exposed part of the internal electrode shielded by the protective layer have a ratio of 1:0.8 to 0.9 therebetween.

In the forming of the protective layers, the protective layers may be formed using a slurry having the same composition as that of the dielectric layer.

In the forming of the protective layers, the protective layers may be formed so as to be adjacent to edges of the connection surface.

In the forming of the protective layers, the protective layers may be formed so as to be adjacent to edges perpendicular to the internal electrodes among the edges of the connection surface.

In the forming of the protective layers, the protective layers may be formed so as to be adjacent to apexes of the connection surface.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing an appearance of a multilayer ceramic electronic component according to an embodiment of the present invention;

FIG. 2 is a perspective view showing a connection surface of a multilayer ceramic electronic component according to an embodiment of the present invention;

FIG. 3 is a front view of the multilayer ceramic electronic component shown in FIG. 2;

FIG. 4 is a perspective view showing a connection surface of a multilayer ceramic electronic component according to another embodiment of the present invention;

FIG. 5 is a view showing an internal structure of the multilayer ceramic electronic component according to another embodiment of the present invention;

FIG. 6 is a flowchart describing a method of manufacturing a multilayer ceramic electronic component according to the embodiment of the present invention; and

FIGS. 7 and 8 are views showing processes included in the method of manufacturing a multilayer ceramic electronic component according to the embodiment of the present invention.

### DETAILED DESCRIPTION OF THE EMBODIMENTS

Embodiments of the present invention will be described in detail with reference to the accompanying drawings. These embodiments will be described in detail for those skilled in the art in order to practice the present invention. It should be appreciated that various embodiments of the present invention are different but are not necessarily exclusive. For example, specific shapes, configurations, and characteristics described in an embodiment of the present invention may be implemented in another embodiment without departing from the spirit and the scope of the present invention. In addition, it should be understood that positions and arrangements of individual components in each disclosed embodiment may be changed without departing from the spirit and the scope of the present invention. Therefore, the detailed description provided hereinafter should not be construed as being restrictive. In addition, the scope of the present invention is defined only by the accompanying claims and their equivalents if appropriate. Similar reference numerals will be used to describe the same or similar functions throughout the accompanying drawing.

Hereinafter, embodiments of the present invention will be described in detail with reference to the accompanying drawings so that those skilled in the art may easily practice the present invention.

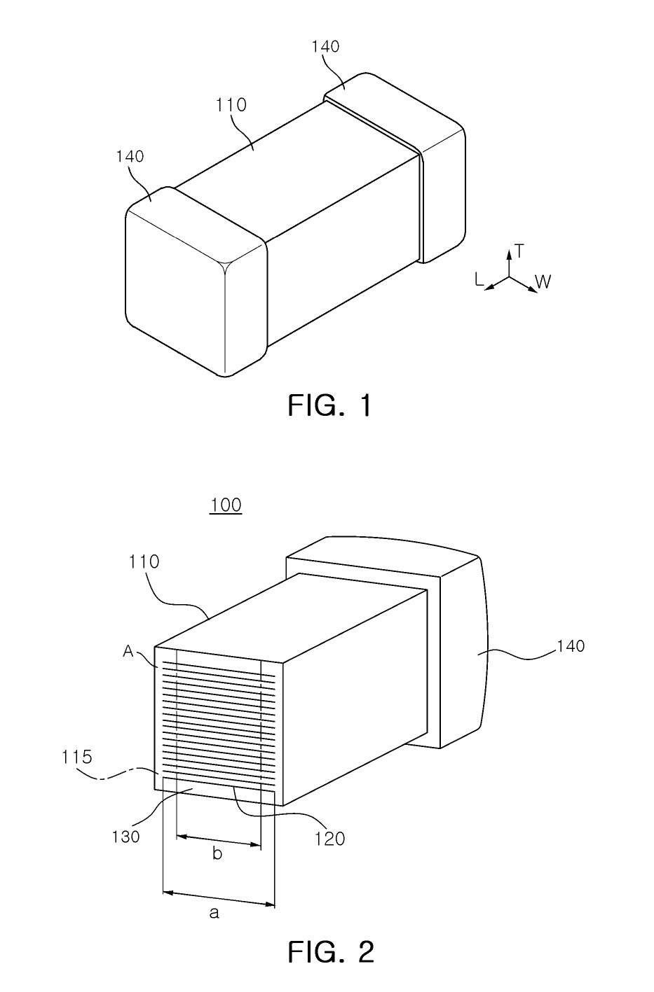

FIG. 1 is a perspective view showing an appearance of a multilayer ceramic electronic component according to an embodiment of the present invention. Referring to FIG. 1, a multilayer ceramic electronic component 100 according to an embodiment of the present invention may include a body part 110 and external electrodes 140 coupled to the body part 110. The body part 110 may be formed by multi-layering internal electrodes (not shown) and dielectric layers (not shown), and the external electrodes may be coupled to certain surfaces (a front surface and a rear surface facing each other in a length direction L and having a hexahedral shape in FIG. 1) of the body part 110.

In order to electrically connect the external electrodes 140 to the internal electrodes, at least partial regions of the internal electrodes may be exposed to the outside on certain surfaces of the body part 110 to which the external electrodes 140 are coupled. That is, although not shown in FIG. 1, a portion of the internal electrodes may be exposed to the outside end surfaces of the body part 110 to which the external electrodes 140 are coupled to thereby be electrically connected to the external electrodes 140.

Hereinafter, for convenience of explanation, a surface to which at least portions of the internal electrodes included in the body part 110 are exposed to thereby be electrically connected to the external electrodes 40 will be defined as a connection surface. In FIG. 1, the end surfaces of the body part 110 may correspond to the connection surface.

FIG. 2 is a perspective view showing a connection surface of a multilayer ceramic electronic component according to an embodiment of the present invention. Referring to FIG. 2, the multilayer ceramic electronic component 100 according to the embodiment of the present invention may include a body part 110 and external electrodes 140. The body part 110 may be formed by multi-layering internal electrodes 120 having conductivity and dielectric layers 130, and connection surfaces of the body part 110 at which at least portions of the internal electrodes 120 are exposed to the outside may be provided with the external electrodes 140 electrically connected to the internal electrodes 120.

Each of the external electrodes 140 may be provided on opposing end connection surfaces of the body part 110 having a rectangular parallelepiped shape. Referring to FIG. 2, the external electrode 140 may be coupled to a connection surface A and a surface of the body part 110 facing the connection surface A. The connection surface A may be provided with protective layers 115. In order to show the protective layer 115 provided on the connection surface A, the external electrode 140 coupled to the connection surface A is not shown in FIG. 2.

The protective layer 115 may partially cover portions of exposed regions of the internal electrodes 120 exposed to the outside at the connection surface A of the body part 110. Referring to FIG. 2, the protective layers 115 may be provided so as to be adjacent to edges orthogonal to a direction in which the internal electrodes 120 are multi-layered, in the connection surface A of the body part 110 and may shield portions of both ends of the internal electrodes 120 exposed to the outside in a width direction thereof. When it is assumed that the overall width of the internal electrode 120 is (a), a width of the protective layer 115 may be determined so that a width b of the internal electrode 120 exposed to the outside without being shielded by the protective layer 115 is 0.8 to 0.9 times that of (a).

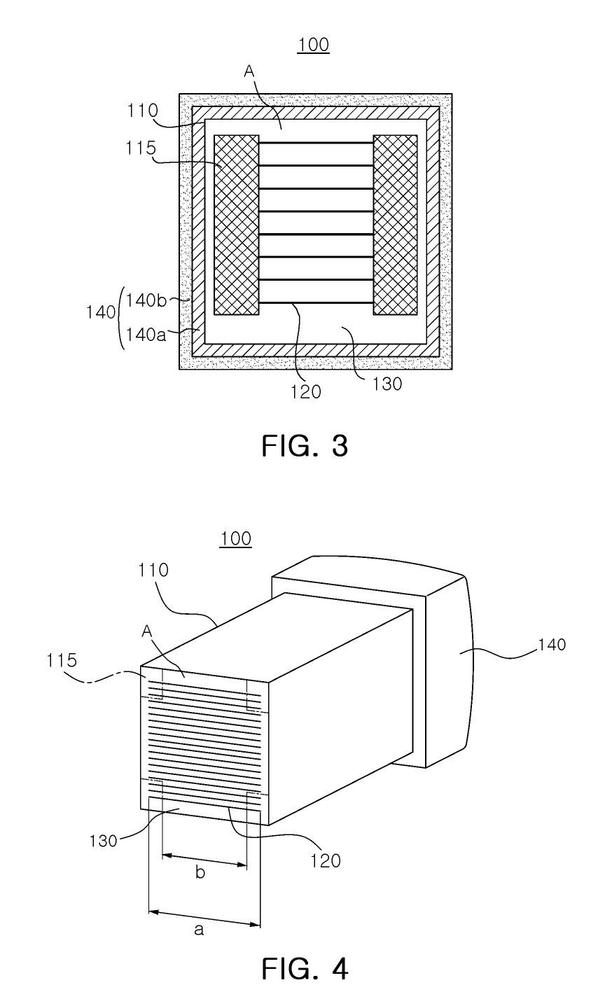

FIG. 3 is a front view of the multilayer ceramic electronic component shown in FIG. 2. That is, FIG. 3 is a view in which the multilayer ceramic electronic component 100 shown in FIG. 2 is viewed from the connection surface A. The internal electrodes 120 multi-layered in a vertical direction may be exposed to the outside through the connection surface A. The protective layers 115 provided so as to be adjacent to the edge of the connection surface A may shield at least partial regions (both ends of the internal electrodes 120 in the width direction thereof in the present embodiment) of the exposed internal electrodes 120.

As described above, the protective layer 115 is disposed at the connection surface A of the body part 110 at which at least portions of the internal electrodes 120 are exposed, to shield partial regions of the exposed internal electrodes 120, whereby the penetration of moisture, ions, conductive foreign materials, and the like, into the internal electrodes 120 relatively close to the external electrodes 140 among the exposed internal electrodes 120, may be prevented.

The external electrode 140 may have a multilayered structure and include a first layer connected to the internal electrode 120 exposed at the connection surface A and a second layer provided at an outer side of the first layer. The first layer may be formed of a metal material (copper, nickel, or the like) so that the external electrode 140 may be electrically connected to the internal electrode 120, and the second layer may be formed of tin (Sn).

FIG. 4 is a perspective view showing a connection surface of a multilayer ceramic electronic component according to another embodiment of the present invention. Referring to FIG. 4, a protective layer 115 may be formed on a connection surface A of a body part 110 to which an external electrode 140 is coupled to shield a portion of internal electrodes 120 exposed to the outside at the connection surface A. Similarly to FIG. 2, in order to show the protective layer 115 provided on the connection surface A, the external electrode 140 coupled to the connection surface A is not shown in FIG. 4.

Unlike FIG. 2, the protective layers 115 shown in FIG. 4 may be disposed so as to be adjacent to apexes of the connection surface A. That is, according to the embodiment of the present embodiment shown in FIG. 2, two protective layers may be disposed per one connection surface so as to be adjacent to the edges of the connection surface of the body part 110; however, according to another embodiment of the present invention shown in FIG. 4, four protective layers may be disposed per one connection surface so as to be adjacent to the apexes of the connection surface.

In FIG. 4, only a portion of the internal electrodes 120 exposed to the outside at the connection surface A may have a region shielded by the protective layers 115 disposed so as to be adjacent to the apexes of the connection surface A. Although FIG. 4 shows that three internal electrodes 120 are partially shielded by the protective layer 115 at each of upper and lower portions in a multilayered direction among the internal electrodes 120 exposed to the outside, the present invention is not necessarily limited thereto. That is, the amount of internal electrodes 120 having a shielded region may increase or decrease according to a size of the protective layer 115.

The external electrode 140 may include a first electrode layer 140a disposed at an inner side thereof and a second electrode layer 140b disposed at an outer side of the first electrode layer 140a. The first electrode layer 140a may be formed of a metal material having conductivity, such as copper, nickel, or the like, and the second electrode layer 140b may be formed of tin (Sn). The first electrode layer 140a disposed at the inner side may be electrically connected to the internal electrodes 120 exposed at the connection surface of the body part 110.

Meanwhile, similarly to the case of FIG. 2, when it is assumed that the overall width of the internal electrode 120 is (a), a width (b) exposed to the outside in the internal electrode 120 shielded by the protective layers 115 may become 0.8 to 0.9 times that of (a).

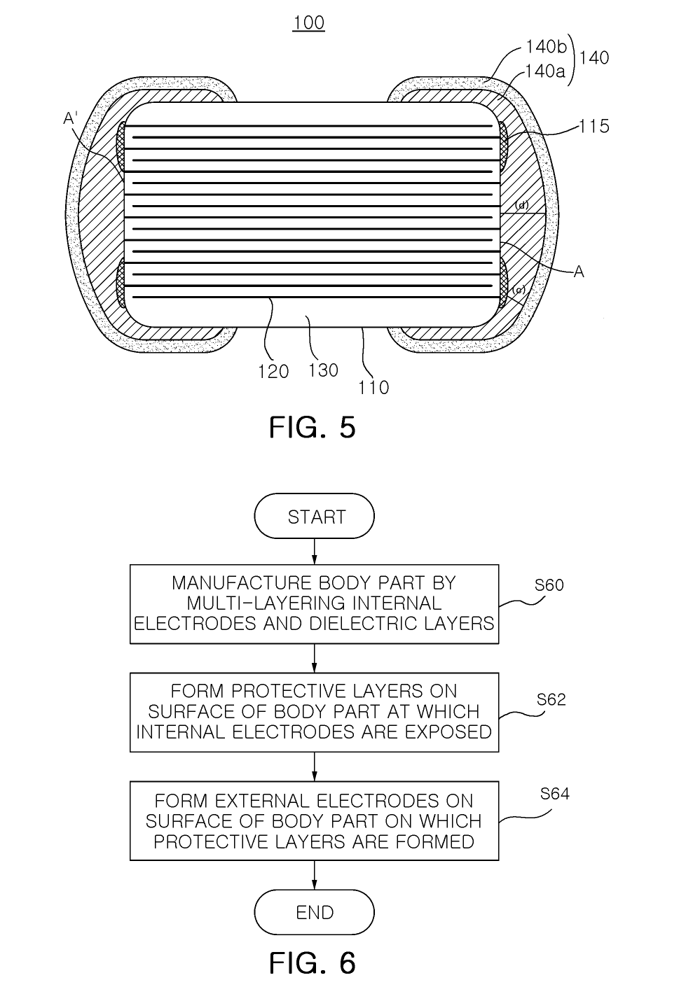

FIG. 5 is a view showing an internal structure of the multilayer ceramic electronic component according to another embodiment of the present invention. Referring to FIG. 5, the multilayer ceramic electronic component 100 according to the present embodiment may include the body part 110 formed by sequentially multi-layering the internal electrodes 120, the external electrodes 140 coupled to connection surfaces A and A′ of the body part 110 at which at least portions of the internal electrodes 120 are exposed, and the protective layers 115 provided on the connection surfaces A and A′ to shield at least portions of the internal electrodes 120 exposed to the outside at the connections surfaces A and A′.

At least portions of the internal electrodes 120 may be exposed to the outside through the connection surfaces A and A′ of the body part 110 shown as the end surfaces in FIGS. 2 and 4. That is, in FIG. 5, internal electrodes 120 electrically connected to a left external electrode 140 may exposed to the outside through the connection surface A′, and internal electrodes 120 electrically connected to a right external electrode 140 may be exposed to the outside through the connection surface A.

The external electrode 140 may include a first electrode layer 140a disposed at an inner side thereof and a second electrode layer 140b disposed an outer side of the first electrode layer 140a, as described in FIG. 4. The first electrode layer 140a may be formed of a metal material having conductivity such as copper, nickel, or the like, and the second electrode layer 140b may be formed of tin (Sn). Each of the first electrode layers 140a may be electrically connected to the internal electrodes 120 at the connection surfaces A and A′.

The external electrodes 140 may have a bent surface. In this case, exposed surfaces of internal electrodes 122 disposed at outer sides of upper and lower portions in a multi-layered direction may have a relatively short distance from the external electrodes 140 as compared to that of exposed surfaces of internal electrodes 124 disposed at an inner side. Therefore, in the case in which a defect such as a crack, or the like, is generated in the external electrode 140, the conductive foreign materials may penetrate into the internal electrode, thereby causing a defect such as deterioration of insulation resistance, deterioration of reliability, and the like. A distance (c) between an exposed surface of an internal electrode 122 disposed at the outer side in the multi-layered direction and the external electrode 140 and a distance (d) between an exposed surface of an internal electrode 124 disposed at an inner side in the multi-layered direction and the external electrode 140 may have a relationship of (c)<(d) therebetween.

Therefore, according to the embodiment of the present invention, the protective layers 115 are disposed between the exposed surfaces of the internal electrodes 122 to the outer side and the external electrodes 140 to block foreign materials from being introduced into the internal electrodes 122 disposed on the external surfaces through corner parts of the external electrodes 140. The foreign materials may also be blocked by increasing a distance between the surface of the body part 110 at which the internal electrode 122 is exposed and the external electrode 140. However, it is difficult to apply the above-mentioned structure to an ultra-high capacitance model of which a cover thickness and a margin width are relatively narrow. The structure including the protective layer 115 according to the embodiment of the present invention is applied, whereby the deterioration of the insulation resistance, the deterioration of the reliability, and the like, may be solved.

TABLE 1

| | | | | | | | Contact |
|---|---|---|---|---|---|---|---|
| Size | Design | Round | Actual | | Contact | Capacitance | Generation |
| (width, | Margin | Abrasion | Margin | Number of | Area Ratio | Percentage | Frequency |
| μm) | Ratio (%) | Ratio (%) | Ratio (%) | Layer | (a/b) | (%) | (ppm) |
| 500 | 25 | 5 | 24 | 200 | 74 | 99.3 | 514 |
| 500 | 25 | 5 | 24 | 200 | 80 | 99.5 | 311 |
| 500 | 25 | 5 | 24 | 200 | 85 | 99.8 | 15 |
| 500 | 25 | 5 | 24 | 200 | 90 | 99.9 | 12 |
| 800 | 23 | 10 | 20 | 250 | 70 | 99.5 | 217 |
| 800 | 23 | 10 | 20 | 250 | 85 | 101.3 | 8 |
| 1200 | 15 | 12 | 13 | 300 | 63 | 99.6 | 81 |
| 1200 | 15 | 12 | 13 | 300 | 85 | 99.4 | 6 |
| 1600 | 13 | 21 | 10 | 350 | 60 | 99.8 | 52 |
| 1600 | 13 | 21 | 10 | 350 | 85 | 99.9 | 5 |

Table 1 shows results obtained by dividing multilayer ceramic electronic components 100 according to sizes, design margin ratios, round abrasion ratios, actual margin ratios, and the numbers of layers of the internal electrodes 120 of the multilayer ceramic electronic components 100 and measuring a capacitance percentage and a contact generation frequency (ppm: a generation frequency of a defect in one million tests) while changing a contact area ratio (a/b) with respect to each of the multilayer ceramic electronic components 100. Referring Table 1, it could be appreciated that when the contact area ratio (a/b) was 85%, the capacitance percentage and the contact generation frequency were the most excellent. Particularly, in the case of the multilayer ceramic electronic component 100 having a width of 500 μm, when the contact area ratio (a/b) was 85% and 90%, a relatively lowest contact generation frequency may be obtained, and when the contact area ratio (a/b) was less than 80%, a relatively high contact generation frequency appears regardless of the size and the design margin ratio of the multilayer ceramic electronic component 100.

FIG. 6 is a flow chart describing a method of manufacturing a multilayer ceramic electronic component according to the embodiment of the present invention. Referring to FIG. 6, the method of manufacturing a multilayer ceramic electronic component 100 according to the embodiment of the present invention starts with manufacturing a body part 100 by multi-layering internal electrodes 120 and dielectric layers 130 (S60). The internal electrode 120 may be formed of a metal material having conductivity, for example, nickel, and the dielectric layer 130 may be formed of barium titanate (BaTiO₃).

The body part 110 manufactured by multi-layering the internal electrodes 120 and the dielectric layers 130 may have a rectangular parallelepiped shape, while a portion of the internal electrodes 120 may be exposed to the outside at least certain of the six surfaces of the body part 110. Since the internal electrodes 120 exposed to the outside need to be electrically connected to external electrodes 140, the internal electrodes 120 may be exposed to the outside at a connection surface of the body part 110 to which the external electrodes 140 are coupled.

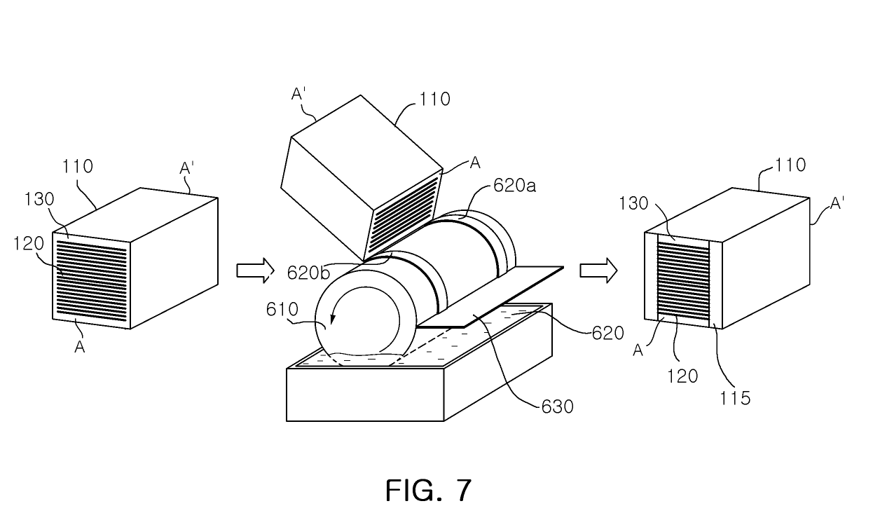

After the body part 110 is manufactured by multi-layering the internal electrodes 120 and the dielectric layers 130, protective layers 114 are formed on the connection surface of the body part 110 at which a portion of the internal electrodes are exposed (S62). A process of forming the protective layer 115 will be described with reference to FIGS. 6 and 7.

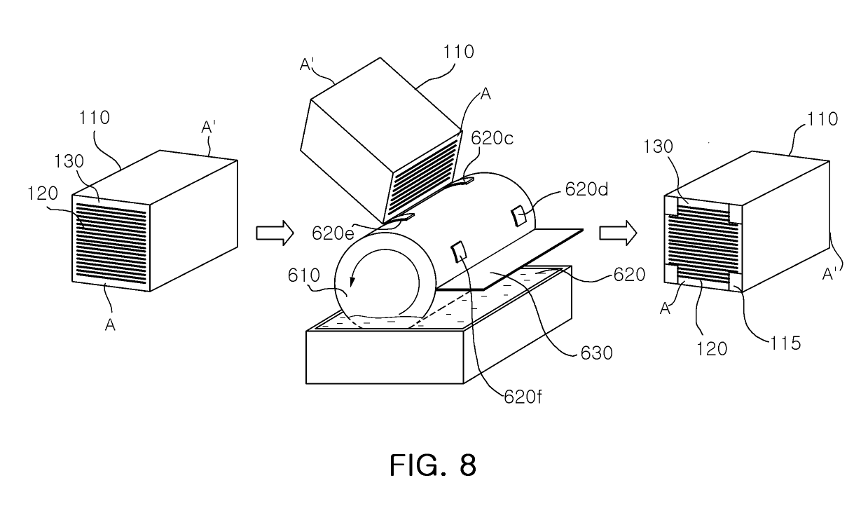

FIGS. 7 and 8 are views showing processes included in the method of manufacturing a multilayer ceramic electronic component according to the embodiment of the present invention. Referring to FIG. 7, in order to form the protective layer 115 on the body part 110 in which the internal electrodes 120 and the dielectric layers 130 are multi-layered, a material for the protective layer 115 may be supplied as a slurry 620. The slurry 620 is contained in a predetermined container, a rubber wheel 620 is rotated, and a portion of the slurry other than a portion thereof required for forming the protective layer 115 in the slurry 620 supplied by being deposited on a surface of the rubber wheel 610 is removed using a blade 630.

It is assumed in FIG. 7 that the protective layers 115 are formed so as to be adjacent to edges perpendicular to the internal electrodes 120 at connection surfaces A and A′. Therefore, slurries 620a and 620b may be disposed in a linear manner on the rubber wheel 610 by the blade 630. The protective layers 115 may be formed so that partial regions of the internal electrodes 120 are shielded from both ends thereof from the width direction thereof by allowing the connection surfaces A and A′ of the body part 110 to contact the line shaped slurries 620a and 620b disposed on the surface of the rotating rubber wheel 610.

FIG. 8 is a view showing a process of forming four protective layers 115 adjacent to the apexes of the connection surfaces A and A′ of the body part 110, as shown in FIG. 2. Referring to FIG. 8, similarly to FIG. 7, a material of the protective layer 115 is processed as a slurry 620 and contained in a predetermined container and a rubber wheel 620 is rotated, such that the slurry 620 for forming the protective layer 115 is supplied by being deposited on a surface of the rubber wheel 610. However, unlike FIG. 7, since the four protective layers 115 need to be formed so as to be adjacent to the apexes of the connection surfaces A and A′ of the body part 110 in FIG. 8, a structure or an operational method of the blade 630 may be different from those of the blade in FIG. 7.

The slurries 620c to 620f may be supplied by being stained on a surface of the rubber wheel 610 in patch form. Each distance between the slurry patches 620c to 620f may correspond to transversal and longitudinal dimensions of front and rear surfaces of the body part 110, and the four protective layers 115 may be formed on the front and rear surfaces of the body part 110 by allowing the connection surfaces A and A′ of the body part 110 to appropriately contact the surface of the rubber wheel 610.

As described above, the overall width of the internal electrode 120 and a width thereof that is not shielded by the protective layer 115 may have a ratio of 1:0.8 to 0.9 therebetween. A thickness of the protective layer 115 is adjusted to determine the ratio between the overall width of the internal electrode 120 and the exposed width, whereby a contact defect and a generation of a crack due to the penetration of foreign materials, such as conductive particles, or the like, may be suppressed.

As set forth above, according to the embodiments of the present invention, the predetermined protective layers are provided between the surface to which the internal electrodes are exposed and the external electrodes in the multilayer ceramic electronic component providing high capacitance even while having a small size to prevent the penetration of the foreign materials such as moisture, ions, conductive particles, and the like, whereby the multilayer ceramic electronic component having excellent reliability may be provided.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic electronic component comprising:
a body part including internal electrodes and dielectric layers and having at least one connection surface to which a portion of the internal electrodes are exposed;
external electrodes coupled to the connection surface to thereby be electrically connected to the internal electrodes; and
protective layers provided on the connection surface so as to shield at least portions of the internal electrodes exposed at the connection surface,
a width of an exposed part of the internal electrode shielded by the protective layer having be 0.8 to 0.9 of that of an overall width of the internal electrode.

2. The multilayer ceramic electronic component of claim 1, wherein the protective layer is formed so as to be adjacent to an edge of the connection surface.

3. The multilayer ceramic electronic component of claim 2, wherein the edge of the connection surface is perpendicular to a width direction of the internal electrode.

4. The multilayer ceramic electronic component of claim 1, wherein the protective layer is formed so as to be adjacent to an apex of the connection surface.

5. The multilayer ceramic electronic component of claim 1, wherein the protective layer is formed between the connection surface and the external electrode.

6. The multilayer ceramic electronic component of claim 5, wherein a distance between the protective layer and the external electrode is smaller than a distance between the connection surface and the external electrode.

7. The multilayer ceramic electronic component of claim 1, wherein the protective layer is formed of the same material as that of the dielectric layer.

8. A method of manufacturing a multilayer ceramic electronic component, the method comprising:
manufacturing a body part by multi-layering internal electrodes and dielectric layers;
forming protective layers on partial regions of a connection surface to which at least portions of the internal electrodes in the body part are exposed, the protective layers shielding at least portions of the internal electrodes exposed at the connection surface; and
providing external electrodes on the connection surface on which the protective layers are formed,
the forming of the protective layers being performed so that the overall width of the internal electrode and a width of an exposed part of the internal electrode shielded by the protective layer have a ratio of 1:0.8 to 0.9 therebetween.

9. The method of claim 8, wherein in the forming of the protective layers, the protective layers are formed using a slurry having the same composition as that of the dielectric layer.

10. The method of claim 8, wherein in the forming of the protective layers, the protective layers are formed so as to be adjacent to edges of the connection surface.

11. The method of claim 9, wherein in the forming of the protective layers, the protective layers are formed so as to be adjacent to edges perpendicular to the internal electrodes among the edges of the connection surface.

12. The method of claim 8, wherein in the forming of the protective layers, the protective layers are formed so as to be adjacent to apexes of the connection surface.
